(19) United States
(12) Patent Application Publication
(10) Pub. No.: US 2015/0309580 A1
(43) Pub. Date: Oct. 29, 2015

(54) METHOD AND COMPUTING UNIT FOR FACILITATING INTERACTIONS OF A GROUP OF USERS WITH GESTURE-BASED APPLICATION

(71) Applicant: Wipro Limited, Bangalore (IN)

(72) Inventors: Amit Kumar, Patna (IN); Sheeba Raj, Bangalore (IN)

(21) Appl. No.: 14/299,852

(22) Filed: Jun. 9, 2014

(30) Foreign Application Priority Data
Apr. 25, 2014 (IN) 2096/CHE/2014

(51) Int. Cl. G06F 3/01; G06K 9/00

(52) U.S. Cl. CPC G06F 3/017; G06K 9/00355; G06K 9/00342

(57) ABSTRACT

Embodiments of the present disclosure provide a method for facilitating interactions, with a gesture-based application, of a group of users. The method comprises identifying, by a computing unit of an interactive device, the group based on information received from sensors associated with the interactive device. Then, an interaction intensity value associated with each of the users is determined. The interaction intensity value is indicative of the level of activity of the each of the users. Next, at least one active user among the group of users is identified based on an order of the interaction intensity values. Lastly, gestures of the at least one active user towards the gesture-based application are tracked for facilitating interactions with the gesture-based application.

This application claims the benefit of Indian Patent Application Serial No. 2096/CHE/2014, filed Apr. 25, 2014, which is hereby incorporated by reference in its entirety.

### FIELD OF THE INVENTION

The present disclosure relates to gesture-based interactions. In particular, embodiments of present disclosure include a method and a computing unit of an interactive device for facilitating interactions of a group of users with gesture-based application.

### BACKGROUND OF THE INVENTION

In gesture-based applications, one or more users are increasingly interacting with a computing device. The computing device includes, but is not limited to, computer, laptop, tablet, workstation, and other electronic devices. Usually, the gesture-based applications enable the one or more users to interact upon detecting gestures of each of the one or more users with respect to the computing device. The gestures of the one or more users are detected by detecting units of the computing device. The detecting units include, but are not limited to, cameras and motion sensors. Upon detecting the gestures, one or more corresponding actions are performed with the gesture-based applications.

Generally, the one or more users start interacting with the gesture-based application when the one or more users are detected by the detecting unit. Sometimes, the one or more users are not detected by the detecting unit when the one or more users are out of field of view of the detecting unit. But, the one or more users are not aware whether the one or more users are being detected or not. Therefore, in such a case, the one or more users who are not being detected are not facilitated for interactions with the gesture-based application. Particularly, conventional methods do not provide a feedback to the users of being detected for making interactions towards the application.

Typically, the gesture-based applications provide single user interaction at a given point of time. For example, consider two users namely user 1 and user 2 shopping online using a touch screen device. At first, the user 1 is enabled to interact upon identifying the user 1 is in field of view of the detecting unit of the touch screen device. While the user 1 is in field of view of the detecting unit, the user 2 is not detected or recognized by the detecting unit. Thus, the user 2 is not enabled to interact while the user 1 is interacting. For enabling the user 2 to interact, the user 1 has to go out of the field of view of the detecting unit and user 2 has to be within the field of view of the detecting unit. In this way, only one user is enabled at a time to interact with the gesture-based application.

Few existing method allows multiple users interaction with the gesture-based applications. But, each user is provided with predefined interaction and time beforehand. Therefore, the users cannot interact using dynamic gestures randomly or simultaneously.

Further, in an event of multiple user interaction, it is difficult to track gestures of each user since more than one user may be making the gestures for interacting with the gesture-based application. Particularly, there exists an uncertainty to identify which user has made a gesture with the gesture-based application. Thus, the above-mentioned problem exists in the field of existing gesture-based applications.

### SUMMARY OF THE INVENTION

Embodiments and aspects of the disclosure are described in detail herein and are considered a part of the claimed disclosure.

Disclosed herein is a computer implemented method for facilitating interactions, with a gesture-based application, of a group of users. The method comprises identifying, by a computing unit of an interactive device, the group based on information received from sensors of the interactive device. Then, an interaction intensity value associated with each of the users is determined. The interaction intensity value is indicative of the level of activity of the each of the users. Next, at least one active user among the group of users is identified based on an order of the interaction intensity values. Lastly, gestures of the at least one active user towards the gesture-based application are tracked for facilitating interactions with the gesture-based application.

In an aspect of the present disclosure, a computing unit of an interactive device for facilitating interactions, with a gesture-based application, of a group of users is disclosed. The computing unit comprises a processor and a memory communicatively coupled to the processor. The memory stores processor-executable instructions, which, on execution, cause the processor to identify the group based on information received from sensors of associated with the interactive device. Then, the processor determines an interaction intensity value associated with each of the users. The interaction intensity value is indicative of the level of activity of the each of the users. Next, the processor identifies at least one active user among the group of users based on an order of the interaction intensity values. Lastly, the processor tracks gestures of the at least one active user towards the gesture-based application for facilitating interactions with the gesture-based application.

In another aspect of the present disclosure, a non-transitory computer readable medium including instructions stored thereon is provided. The instructions when processed by a processor cause a computing unit to perform the acts of identifying the group based on information received from sensors associated with an interactive device. The processor further causes the computing unit to determine an interaction intensity value associated with each of the users, wherein the interaction intensity value is indicative of the level of activity of the each of the users. Further, the processor causes the computing unit to identify at least one active user among the group of users based on an order of the interaction intensity values; and tracking gestures of the at least one active user towards the gesture-based application for facilitating interactions in the gesture-based application.

The foregoing summary is illustrative only and is not intended to be in any way limiting. In addition to the illustrative aspects, embodiments and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a block diagram of an interactive device for facilitating interactions, with a gesture-based application, of a group of users in accordance with some embodiments of the present disclosure;

FIG. 2 illustrates an exemplary pictorial representation for identifying a group of users for facilitating interactions with a gesture-based application in accordance with some embodiments of the present disclosure;

FIG. 3 illustrates an exemplary user interface of the interactive device showing the gesture based application in accordance with some embodiments of the present disclosure;

FIG. 4 illustrates an exemplary user interface of the interactive device highlighting at least active user in the gesture based application in accordance with some embodiments of the present disclosure;

FIGS. 5a and 5b show an exemplary pictorial representation for identifying a change in group of users in accordance with some embodiments of the present disclosure;

FIG. 6 shows a flowchart illustrating a method for facilitating interactions, with a gesture-based application, of a group of users, in accordance with some embodiments of the present disclosure; and

FIG. 7 shows a flowchart illustrating identification of a change in a group and a change of the least one active user in a group in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Accordingly, the present disclosure relates to a computer implemented method for facilitating interactions, with a gesture-based application, of a group of users. The method comprises detecting the users in the group by sensors associated with an interactive device. The group of users is detected by the sensors when the users are in field of view of the sensors. In other words, the group of users is detected when the users comes within coverage area of the sensors. The coverage area may vary from 0 degree to 360 degree angle. A computing unit of the interactive device identifies number of users in the group and determines an interaction intensity value associated with each of the users. In an embodiment, based on an order of the interaction intensity value associated with each of the users, an active user is recognized. Upon identifying the active user, the gestures including one or more actions of the active user towards the application is tracked down. In an embodiment, a change of the active user with a new active user is recognized based on a change in the order of interaction intensity value. In an embodiment, a change in the group is determined by identifying addition or deletion of users in the group. In this way, the interaction of each user in the group is managed. In one embodiment, each user may be facilitated to make gestures for interactions with the application without causing a user to wait for the other user to finish the task of gesturing. Additionally, a notification in a form of visual clues may be generated on a display unit associated with the interactive device upon identifying each user. In this way, the users are provided with feedback of being identified for facilitating the interactions with the application.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

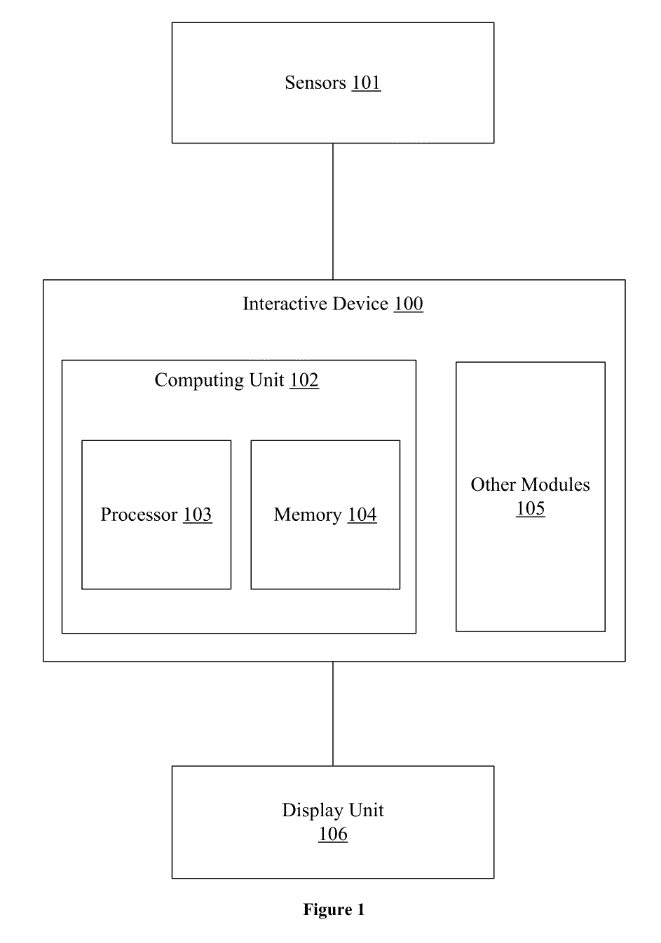

FIG. 1 illustrates a block diagram of an interactive device 100 for facilitating interactions, with a gesture-based application, of a group of users in accordance with some embodiments of the present disclosure.

As shown in FIG. 1, the interactive device 100 comprises one or more components coupled with each other. In one implementation, the interactive device 100 comprises a computing unit 102. In a non-limiting example, the interactive device 100 includes, but not limited to, a mobile phone, Television, Personal Digital Assistant (PDA), laptop, computer, contactless device, gaming device, smartphone, tablet and any other gesture sensing device. In an embodiment, the interactive device 100 is a gesture based device configured to enable interactions of the users with the gesture-based application.

The interactive device 100 is configured to recognize actions including, but are not limited to, position, motion, movement, magnitude of gesture. The gestures include, but are not limited to, a palm-pull gesture, palm-push gesture, a flick gesture, a graffiti-style gesture, a two-finger gesture, tapping gestures, tilting gestures, shaking gestures, and other suitable gesture made in relation to the gesture-based application. The gestures may be single point or multipoint. The interactive device 100 may use technologies including, but not limited to, resistive screen technology, surface acoustic wave technology, capacitive screen technology, strain gauge screen technology, optical imaging screen technology, dispersive signal screen technology, and acoustic pulse recognition screen technology.

In one implementation, the interactive device 100, as shown in FIG. 1, includes a central processing unit (“CPU” or “Processor”) 103, a memory 104, and other modules 105. Processor 103 may comprise at least one data processor for executing program components and for executing user- or system-generated requests. A user may include a person, a person using a device such as those included in this disclosure, or such a device itself. The processor 103 may include specialized processing units such as integrated system (bus) controllers, memory management control units, floating point units, graphics processing units, digital signal processing units, etc. The processor 103 may include a microprocessor, such as AMD Athlon, Duron or Opteron, ARM's application, embedded or secure processors, IBM PowerPC, Intel's Core, Itanium, Xeon, Celeron or other line of processors, etc. The processor 103 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc. Among other capabilities, the processor 103 is configured to fetch and execute computer-readable instructions stored in the memory 104. The memory 104 stores processor-executable instructions, which, on execution, cause the processor 103 to perform one or more steps. The memory 104 can include any non-transitory computer-readable medium known in the art including, for example, volatile memory (e.g., RAM), and/or non-volatile memory (e.g., EPROM, flash memory, etc.).

In one implementation, the interactive device 100 is associated with sensors 101. In an embodiment, the sensors 101 are included in the interactive device 100. In another embodiment, the sensors 101 are associated with the interactive device 100 externally. As an example, the sensors 101 is mounted external to the interactive device 100 and are communicatively connected via communication technology includes, but not limiting to wired technology and wireless technology. The sensors 101 may be selected from at least one of a camera, an infrared (IR) sensor, a Red-Green-Blue (RGB) sensor, a Sonar sensor, a laser sensor and a Radio Frequency (RF) sensor. The camera includes, but is not limited to, three dimensional camera, digital camera, color camera etc.

In one implementation, the interactive device 100 is associated with a display unit 106. In an embodiment, the display unit 106 is included in the interactive device 100. In another implementation, the display unit 106 is associated to the interactive device 100 externally. As an example, the display unit 106 is mounted external to the interactive device 100 and are communicatively connected via communication technology includes, but not limited to wired technology and wireless technology.

In an embodiment, the gestures are performed on the display unit 106. In such embodiment, the display unit 106 acts as user interface for the interactive device 100. The users may make gestures, movements, motions etc. with a gesture-based application by using a marker. The marker may include, but is not limited to, wearable portable devices, handheld portable devices including, but not limited to, stylus, pen, pencil, hand, finger, pointing device, game grip and joystick etc. The marker is associated to the interactive device 100 via communication technology for enabling the interactions of users with the gesture-based applications. The communication technology includes, but is not limited to wired technology and wireless technology. In an embodiment, the interactive device 100 is associated with accelerometers and gyros to determine acceleration and orientation of gestures, motions, movements, and positions of the users. The accelerometers include 3-axis accelerometers.

The other modules 105 of the interactive device 100 may include an input/output (I/O) interface for communicating with input/output (I/O) devices (not shown in FIG. 1). The interactive device 100 is installed with one or more interfaces (not shown in FIG. 1) like software and/or hardware to support one or more communication links (not shown) for providing access to the gesture-based application. In an embodiment, the interactive device 100 implements a web browser or Linux client to communicate with the gesture-based application through a distributed network (not shown). Secure web browsing may be provided using secure hypertext transport protocol (HTTPS), secure sockets layer (SSL), Transport Layer Security (TLS), etc. Web browsers may utilize facilities such as Asynchronous JavaScript and Extensible Markup Language (AJAX), Dynamic Hyper Text Markup Language (DHTML), Adobe Flash, JavaScript, Application Programming Interfaces (APIs), etc. In an embodiment, the interactive device 100 communicates with the distributed network via a network interface (not shown in FIG. 1). The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc. The distributed network includes, but are not limited to, a direct interconnection, an e-commerce network, a peer to peer (P2P) network, local area network (LAN), wide area network (WAN), wireless network (e.g., using Wireless Application Protocol), the Internet, and Wi-Fi etc.

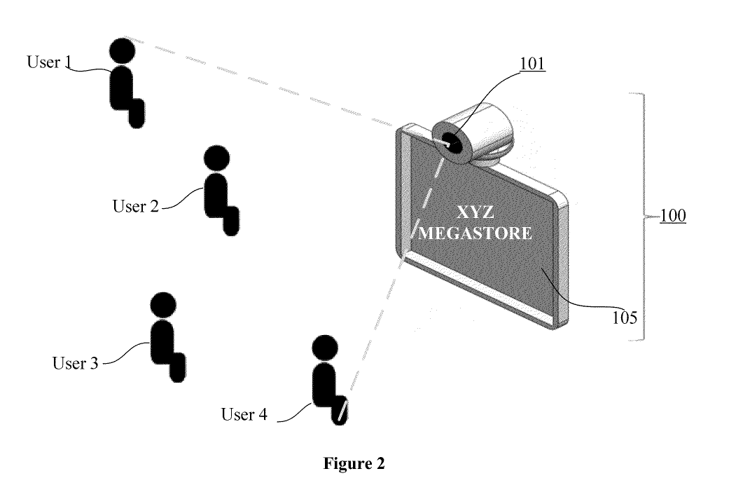

FIG. 2 illustrates an exemplary pictorial representation for identifying a group of users for facilitating interactions with a gesture-based application in accordance with some embodiments of the present disclosure. In the illustrated FIG. 2, a group of four users i.e. user 1, user 2, user 3 and user 4 are in field of view of the sensors 101 associated with the interactive device 100. In operation, the users may visit a gesture-based website or application using the interactive device 100 for interacting with the gesture-based application. For example, the group of four users is interacting with the online store namely “XYZ Megastore”. The sensors 101 detect each of the user 1, user 2, user 3 and user 4 who are in field of view of the sensors 101.

The sensors 101 determine one or more attributes associated to each of the users (for example, user 1, user 2, user 3 and user 4) who are in the field of view of the sensors 101. The one or more attributes include, but are not limited to, color image, depth image and body matrix of each of the users. The color image includes a chrominance of the image of each of the users. The depth image includes a distance with respect to each pixel of the image from point of view of the sensors 101. The body matrix is an array of three dimensional points mapped to the user in the image. Particularly, the body matrix includes a three dimensional skeletal model of each of the user. In an embodiment, information including the one or more attributes retrieved by the sensors 101 is processed by the processor 103 of the computing unit 102 of the interactive device 100.

Based on the information received from the sensors 101, the group of users is identified by the processor 103. For example, a group of four users i.e. user 1, user 2, user 3 and user 4 is identified by the processor 103 based on the information received from the sensors 101. In an embodiment, a number of users in the group are identified by a count tracker (not shown) of the computing unit 102. For example, if there are four users in field of view of the sensors 101, then the count tracker tracks the number of users as four. In an embodiment, a sequence of identified users in the group is created i.e. a sequence of the tracked users is created by a group sequence creator (not shown) of the computing unit 102. For example, a sequence in which the each user is tracked are in order “user 1”, “user 3”, “user 4” and “user 2”. Then, the same sequence in the order of “user 1”, “user 3”, “user 4” and “user 2” is created by the group sequence creator.

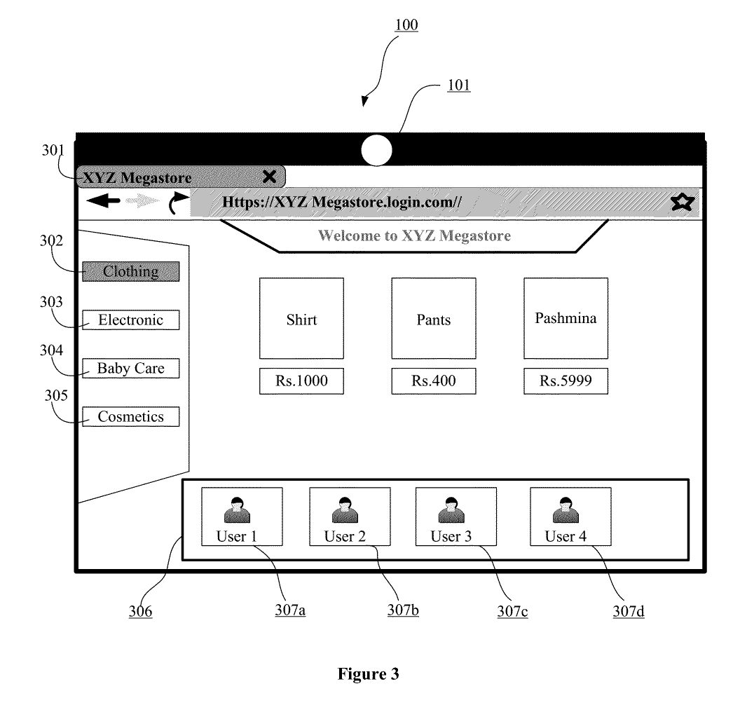

Upon identifying each user in the group, a visual clue or visual layout of each of the user is generated by a visual clue generator (not shown) of the computing unit 102 on the display unit 105 of the interactive device 100 (best shown in FIG. 3). The visual clue or visual layout is a virtual representation of each of user being identified for interacting with the gesture-based application.

Upon identifying the group of users, the processor 103 determines an interaction intensity value associated with each of the user in the group. In an embodiment, an intensity watcher (not shown) of the computing unit 102 determines the interaction intensity value associated with each of the user in the group. For example, interaction intensity value associated with each of user 1, user 2, user 3 and user 4 is determined. In an embodiment, the interaction intensity value is indicative of the level of activity of each of the users in the group. The level of activity includes, but is not limited to, number of gestures in a predefined time, distance of the user with respect to the sensors 101, change of position of the user, change in orientation of the user and related level of activities. In an embodiment, the level of activity of one user is compared with the other users by an intensity comparer (not shown) of the computing unit 102. In an embodiment, the level of activity to determine the interaction intensity value is application specific. For example, in education interaction system, consider three students interacting with gesture-based education application. Student 1 is seated near to the sensors 101 than student 2 and student 3. Assuming, both student 1 and student 3 are making gestures for interacting with the gesture-based application. In such situation, student 1 is an active user considering the distance of the user as a measurement for the level of activity. Another example, in gaming system, consider two players playing tennis. Player 1 is nearer to the sensors 101 than player 2. Thus, player 1 is an active user when the player makes gestures like hitting the ball with joystick considering the distance of the user as a measurement for the level of activity.

Based on determination of an order of the interaction intensity values, at least one active user among the group of users is identified. In an exemplary embodiment, the identifying of the at least one active user among the group of users is based on a descending order of the interaction intensity values. For example, assuming user 2 has highest interaction intensity value among all the four users. Next, user 3 has interaction intensity value less than user 2 but greater than other users in the group. Next, user 4 has interaction intensity value less than user 3 and greater than user 1. Thus, the order of the interaction intensity values pertains to users in order of user 2, user 3, user 4 and user 1. In this case, user 2 is identified as an active user among all the four users. Another example, in education system, assuming student 1 has highest interaction intensity value. Next, student 3 has interaction intensity value lesser than student 1 but more than student 2. Thus, student 2 has least interaction intensity value. Then, the descending order of interaction intensity value pertains to students in order of student 1, student 3 and student 2. Therefore, student 1 is considered to be an active user among the three students. In an embodiment, multiple active users may be identified. For example, in group education system, both student 1 and student 2 may be gesturing for answering a question. Assuming the interaction intensity value of the student 1 is 10 and interaction intensity of the student 2 is 9.5. In such context of group education system, both student 1 and student 2 are identified to be active users. Another example, in gaming system, in two player-based games, both the players i.e. player 1 and player 2 are required to play together simultaneously. Assuming, the interaction intensity value of the player 1 is 6.9 and the interaction intensity value of the player 2 is 7.0. Thus, player 1 and player 2 playing a two player-based game are considered to be active users. In an embodiment, the identifying of the at least one active user among the group of users may be based on a descending order of the interaction intensity values.

In an embodiment, a change of the at least one active user in the group is identified. Particularly, a change of the at least one active user with a new active user is identified based on a change in the interaction intensity values. For example, user 3 is identified as next active user after user 1. That is, if the interaction intensity value of the user 3 is more than the user 1, user 2 and user 4, then the user 3 is identified as an active user. For example, player 2 may be identified as next active user after player 1 (being the active user previous to player 2). Particularly, if the interaction intensity value of the player 2 is more than the player 1, then player 2 is identified as an active user.

Upon identifying the at least one active user, the gestures of the active user towards the gesture-based application is tracked. For example, considering the shopping scenario, the gestures such as selecting one or more items from a megastore in a gesture-based application, picking items, dropping the items, providing reviews, exploring to different items etc. are tracked. In education system, the gesture such as answering, drawing, scrolling the page, writing etc. are tracked. In gaming application, the actions of players such as hitting the ball, movement of joystick, motion of the player etc. are tracked.

In an embodiment, a unique identifier is assigned to the at least one active user. In an embodiment, the unique identifier is assigned by a unique key assignor (not shown) of the computing unit 102. For example, user 1 being an active user may be assigned with a unique identifier as IDUSER104. In an alternative embodiment, a unique identifier is assigned to each of the identified users in the group. A unique identifier is assigned in order to identify the user when the user interacts with the gesture-based application. User 1, user 2, user 3 and user 4 may be assigned with unique identifier as IDUSER104, IDUSER107, IDUSER118 and IDUSER120 respectively. Further, a unique session for the at least one active user is created for interactions with the gesture-based application. The unique session defines the session for carrying out one or more actions towards the gesture-based application. The unique session includes details of the at least one active user such as a unique identifier assigned to the at least one active user and one or more actions performed by the at least one active user towards the gesture-based application. Table 1 show the unique session of the least one active user in gesture-based shopping scenario:

TABLE 1

| User(s) | Unique Identifier | Session |
|---|---|---|
| User 1 | IDUSER104 | Picked the Shirt of |
| | | Rs.400 |
| | | Picked camera |
| | | lenses of Rs.10,000 |

The above Table 1 shows that the user 1 being the active user has the unique identifier as IDUSER104. The user 1 has performed one or more actions which include picking of shirt of Rs.400 and camera lenses of Rs.10, 000. The Table 1 illustrates the unique session of only one active user as an example. However, a person skilled in the art should understand that, a unique session for multiple active users may be created. Table 2 shows the unique session of the multiple active users i.e. two active users in gesture-based shopping scenario.

TABLE 2

| User(s) | Unique Identifier | Session |
|---|---|---|
| User 1 | IDUSER104 | Picked the Shirt of Rs.400 |
| | | Picked camera lenses of |
| | | Rs.10,000 |
| User 2 | IDUSER107 | Provided the review rates over |
| | | the item Shirt |
| | | Picked pants of Rs.5999 |
| | | Recommended an item Shoes |

The above Table 2 shows that the user 1 being the active user has the unique identifier as IDUSER104. The user 1 has performed one or more actions which include picking of shirt of Rs.400 and camera lenses of Rs.10, 000. The user 2 while being the active user has performed one or more actions which include providing the review rates over the Shirt, picking the pants of Rs.5999 and recommending an item Shoes.

In an embodiment, the one or more actions performed through gestures, movements, motions etc. by the at least one active user is stored in the memory 104 of the computing unit 102. The memory 104 may be implemented as a volatile memory device utilized by various elements of computing unit 102 (e.g., as off-chip memory). For these implementations, the memory 104 may include, but is not limited to, random access memory (RAM), dynamic random access memory (DRAM) or static RAM (SRAM). In some embodiment, the memory 104 may include any of a Universal Serial Bus (USB) memory of various capacities, a Compact Flash (CF) memory, an Secure Digital (SD) memory, a mini SD memory, an Extreme Digital (XD) memory, a memory stick, a memory stick duo, an Smart Media Cards (SMC) memory, an Multimedia card (MMC) memory, and an Reduced-Size Multimedia Card (RS-MMC), for example, noting that alternatives are equally available. Similarly, the memory 104 may be of an internal type included in an inner construction of a corresponding computing unit 102, or an external type disposed remote from such a computing unit 102. Again, the memory 104 may support the above-mentioned memory types as well as any type of memory that is likely to be developed and appear in the near future, such as phase change random access memories (PRAMs), units, buzzers, beepers etc. The one or more units generate a notification for indicating the identified ferroelectric random access memories (FRAMs), and magnetic random access memories (MRAMs), for example.

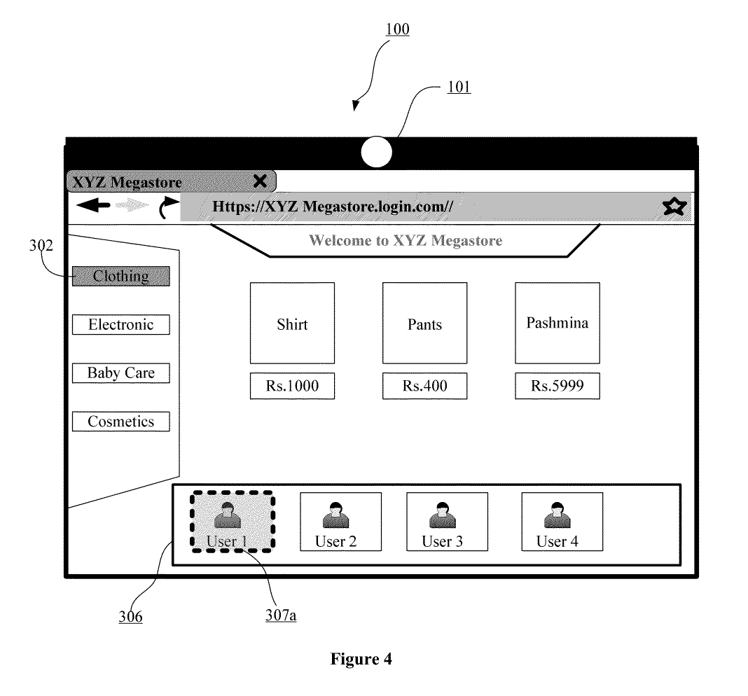

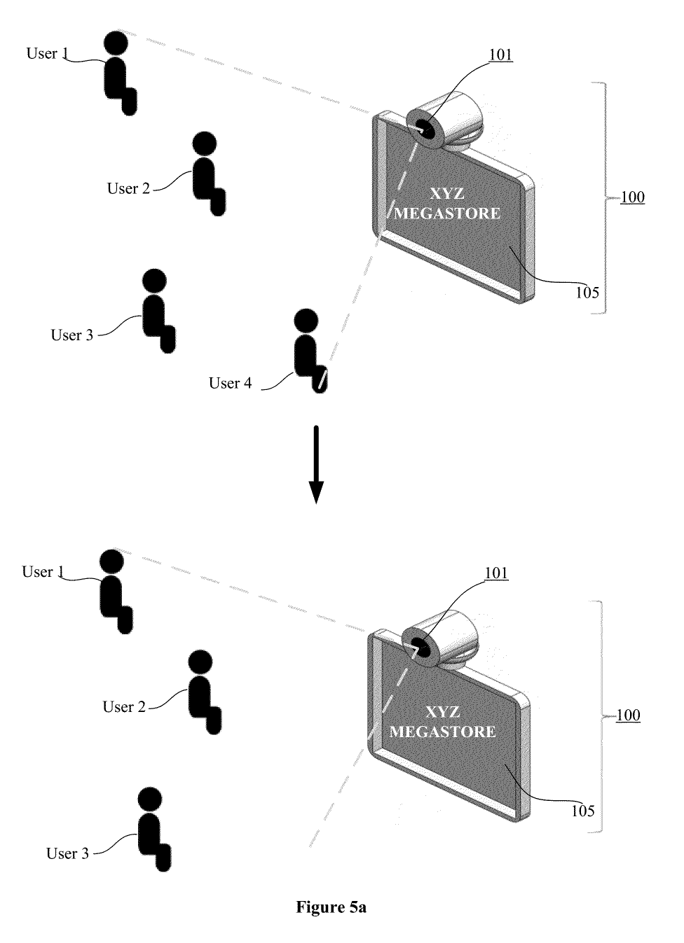

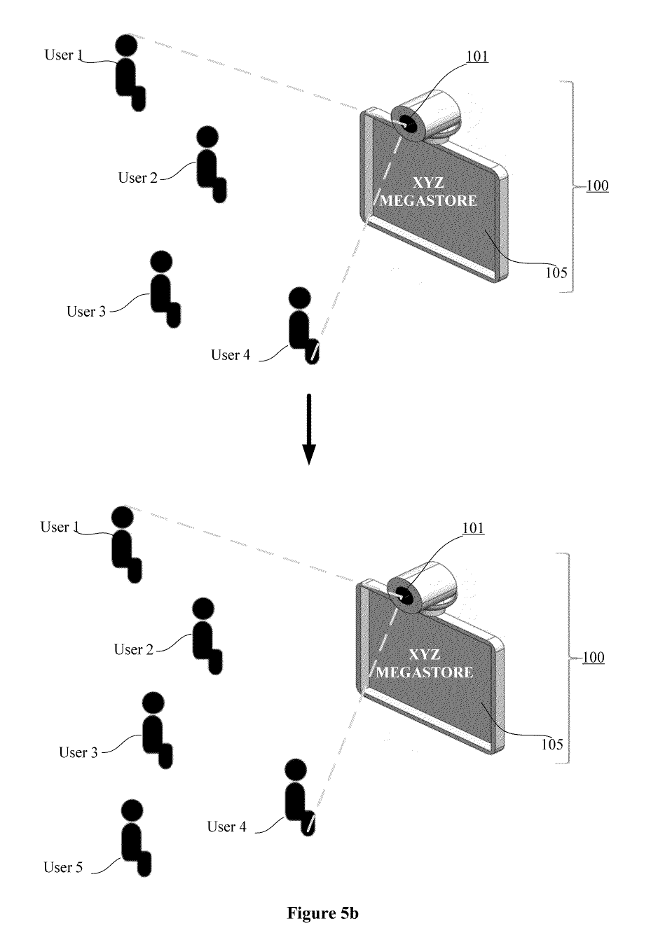

In an embodiment, a notification is generated by the visual clue generator for indicating the at least one active user (best shown in FIG. 4). In an embodiment, a change in the group of users is identified by identifying at least one of addition and deletion of at least one user in the group (best shown in FIGS. 5a and 5b).

FIG. 3 illustrates an exemplary display unit 106 of the interactive device 100 showing the gesture based application in accordance with some embodiments of the present disclosure. In the illustrated FIG. 3, an online shopping store scenario is illustrated. A group of four users i.e. user 1, user 2, user 3 and user 4 accesses an online shopping store by keying in the website referred to as “XYZ Megastore” 301. Upon entering the online store, various store categories are displayed such as clothing 302, electronic 303, baby care 304 and cosmetics 305. Considering the users would like to shop under clothing 301, therefore the users choose the clothing 302 category. Upon choosing the clothing 302, various cloth items such as shirt, pants, pashmina etc. are displayed along with their price tags. Meanwhile, when the group of four users is identified by the computing unit 102, the visual layout of each of the users is generated on the display unit 105. In an embodiment, a layout 306 is created for generating visual layout for each of the user in the group. In the illustrated FIG. 3, the visual layout of user 1 is referred by 307a, visual layout of user 2 is referred by 307b, visual layout of user 3 is referred by 307c and visual layout of user 4 is referred by 307d.

FIG. 4 illustrates an exemplary display unit 106/user interface of the interactive device 100 highlighting at least one active user in gesture-based application in accordance with some embodiments of the present disclosure. In an embodiment, the interactive device 100 is associated with one or more units for alerting the at least one active user. In an embodiment, a visual alert, an audio alert and an audio-visual alert is generated for indicating the identified at least one active user. The notification includes, but does not limit to, highlighting the visual clue or visual layout of the active user on the display unit 105. Considering user 1 among other three users i.e. user 2, user 3 and user 4 makes a gesture to pick an item from displayed cloth items. In such case, user 1 is identified as the active user. Thus, the visual layout 307a pertaining to the user 1 is highlighted. This enables the user 1 to receive a feedback of being identified for interacting with the gesture-based application. Further, the marker using which the user makes the gestures may be notified for indicating the active user. For example, the player 1 is an active user. Then, the joystick using which the player 1 is playing is lit up or vibrated for indicating the player 1 as the active user.

FIGS. 5a and 5b show an exemplary pictorial representation for identifying a change in group of users in accordance with some embodiments of the present disclosure. For example, consider four users i.e. user 1, user 2, user 3 and user 4 interacting with the gesture-based application. The group of users is identified. FIG. 5a shows the deletion of user from the group when the user goes out of the group. In the illustrated embodiment, user 4 goes out of the interaction, then change in group of users i.e. deletion of user 4 is identified. In such case, user 1, user 2 and user 3 may be enabled to continue with the interactions with the gesture-based application.

FIG. 5b shows addition of user in the group when the user joins the group for interacting with the gesture-based application. In case, a new user i.e. user 5 joins the group, then addition of user is identified and enables the added user 5 to interact with the gesture-based application.

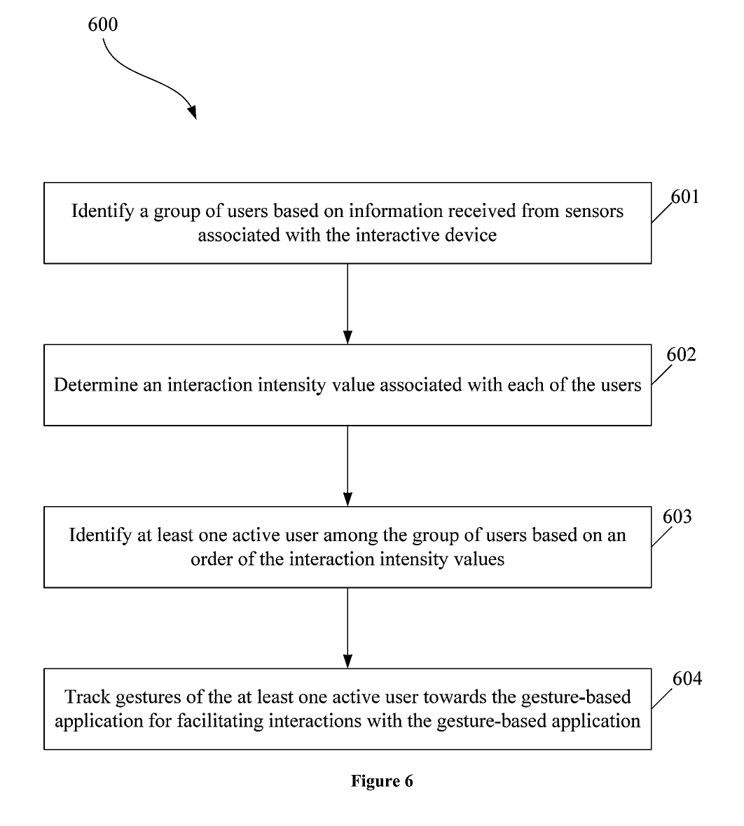

FIG. 6 shows a flowchart illustrating a method for facilitating interactions, with a gesture-based application, of a group of users, in accordance with an embodiment of the present disclosure.

As illustrated in FIG. 6, the method 600 comprises one or more blocks for facilitating interactions of a group of users with a gesture-based application on the interactive device 100. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method 600. Additionally, individual blocks may be deleted from the method 600 without departing from the spirit and scope of the subject matter described herein. Furthermore, the method 600 can be implemented in any suitable hardware, software, firmware, or combination thereof.

At block 601, identify a group of users based on information received from the sensors 101 associated with the interactive device 100. The group of users are detected by the sensors 101 when the group of users is in field of view of the sensors 101. In an embodiment, one or more attributes include, but are not limited to, color image, depth image and body matrix of each of the users are detected. In an embodiment, information including the one or more attributes is processed by the processor 103 of the computing unit 102 of the interactive device 100.

At block 602, determine an interaction intensity value associated with each of the users. In an embodiment, an interaction intensity value associated with each of the users is determined by the computing unit 102. In an embodiment, the interaction intensity value is indicative of the level of activity of the each of the users.

At block 603, identify at least one active user among group of users based on an order of interaction intensity values. In an exemplary embodiment, the at least one active user among the group of users is identified by the computing unit 102 based on a descending order of the interaction intensity values.

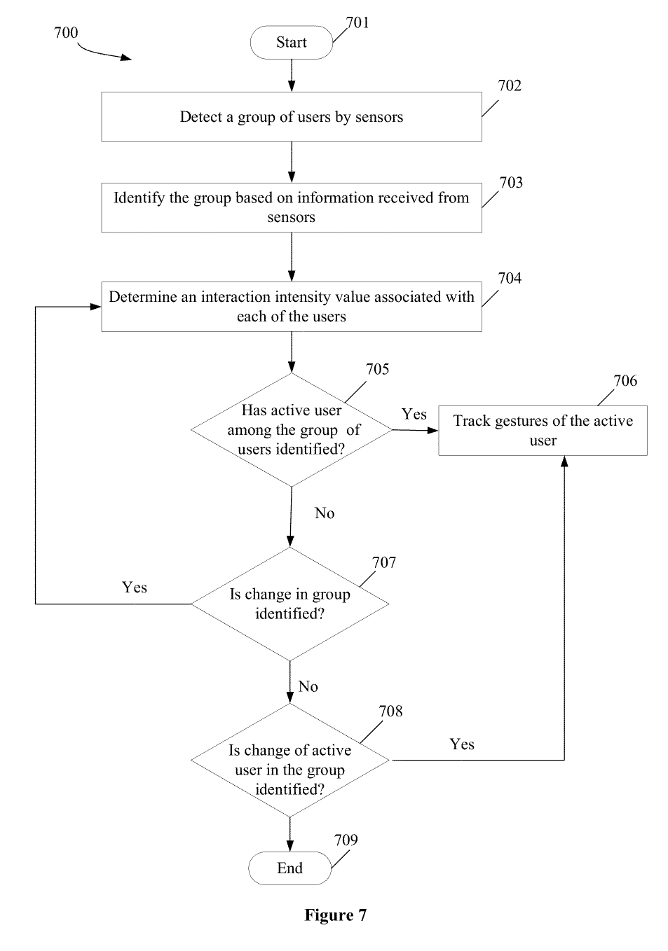

At block 604, track gestures of the at least one active user towards the gesture-based application. In an embodiment, the gestures of the at least one active user towards the gesture-based application are tracked for facilitating interactions with the gesture-based application. In an embodiment, a unique identifier to the at least one active user is assigned. Further, a unique session is created for the at least one active user for facilitating interactions with the gesture-based application. The unique session is created to track the gesture including one or more actions towards the application. In an embodiment, a notification is generated for indicating the identified at least one active user. The notification comprises at least one of a visual alert, an audio alert and an audio-visual alert. The one or more actions performed by the at least one active user is stored in the memory 104 of the computing unit 102. In an embodiment, a change in group of users is identified. The change in group is identified by identifying addition or deletion of user to or from the group. In an embodiment, a change of the least one active user with a new active user is identified. The change of the least one active user is identified based on a change in the interaction intensity value and is illustrated in flowchart 700 of FIG. 7.

The method 700 may be described in the general context of computer executable instructions. Generally, computer executable instructions can include routines, programs, objects, components, data structures, procedures, modules, and functions, which perform particular functions or implement particular abstract data types. The order in which the method 700 is described is not intended to be construed as a limitation, and any number of the described method blocks can be combined in any order to implement the method 700. Additionally, individual blocks may be deleted from the method 700 without departing from the spirit and scope of the subject matter described herein. Furthermore, the method 700 can be implemented in any suitable hardware, software, firmware, or combination thereof.

FIG. 7 shows a flowchart illustrating identification of a change in the group and a change of the least one active user in the group in accordance with an embodiment of the present disclosure.

At block 701, the process of tracking gestures of the least one active user starts.

At block 702, the sensors 101 detect a group of users who are in field of view of the sensors 101.

At block 703, the computing unit 102 identifies the group based on information received from the sensors 101.

At block 704, an interaction intensity value associated with each of the users is determined by the computing unit 102 to identify the at least one active user.

At block 705, a condition is checked whether the at least one active user has been identified. If the least one active user is identified, then the method proceeds to block 706 via “YES” to track the gestures of the identified at least one user.

If no active user is identified, then the method proceeds to block 707 via “NO” where a condition is checked whether a change in group is identified. Particularly, the change in group of users is identified by identifying addition or deletion of least one user in the group.

If there is a change in the group of users, then the method proceeds to block 704 via “YES” to determine the interaction intensity value associated with each user. Particularly, the interaction intensity value associated with each user who has been added or deleted to or from the group is determined.

If there is no change in the group of users at block 707, then the method proceeds to block 708 via “NO” to check a condition whether a change of the at least active user with a new active user. If there is a change of the at least one active user is identified, then the method proceeds to block 706 via “YES” to track the gestures of the new active user. The change of the least one active user with a new active user is identified based on a change in the interaction intensity value. If there is no change of the at least one active user, then the method proceeds to block 709 via “NO” to end the process.

Advantages of the embodiment of the present disclosure are illustrated herein.

Embodiment of the present disclosure manages interactions of each user in the group.

Embodiment of the present disclosure provides a feedback to the users by creating visual layout of each of the user of being identified for interactions with application.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 6 and 7 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Interactive Device |
| 101 | Sensors |
| 102 | Computing Unit |
| 103 | Processor |
| 104 | Memory |
| 105 | Other Modules |
| 106 | Display Unit/User Interface |

What is claimed:

1. A method for facilitating interactions with a gesture-based application, the method comprising:
identifying, by an interaction management computing device, the group based on information received from sensors associated with the interactive device;
determining, by the interaction management computing device, an interaction intensity value associated with each of the users, wherein the interaction intensity value is indicative of the level of activity of the each of the users;
identifying, by the interaction management computing device, at least one active user among the group of users based on an order of the interaction intensity values; and
tracking, by the interaction management computing device, gestures of the at least one active user towards the gesture-based application for facilitating interactions with the gesture-based application.

2. The method as claimed in claim 1 further comprising:
assigning, by the interaction management computing device, a unique identifier to the at least one active user; and
creating, by the interaction management computing device, a unique session for the at least one active user for facilitating interactions with the gesture-based application.

3. The method as claimed in claim 1 further comprising generating, by the interaction management computing device, a notification for indicating the identified at least one active user, wherein the notification comprises at least one of a visual alert, an audio alert and an audio-visual alert.

4. The method as claimed in claim 1, wherein the identifying of the at least one active user among the group of users is based on a descending order of the interaction intensity values.

5. The method as claimed in claim 1 further comprising storing, by the interaction management computing device, one or more actions performed towards the gesture-based application by the at least one active user in a memory of the computing unit.

6. The method as claimed in claim 1, wherein the information comprises at least one of color image, depth image and body matrix of each of the users.

7. The method as claimed in claim 1 further comprising identifying, by the interaction management computing device, a change in the group of users by identifying at least one of addition and deletion of at least one user in the group.

8. The method as claimed in claim 1 further comprising identifying, by the interaction management computing device, a change of the at least one active user in the group based on a change in the interaction intensity values.

9. An interaction management computing device comprising:
a processor;
a memory, wherein the memory coupled to the processor which are configured to execute programmed instructions stored in the memory comprising:
identifying the group based on information received from sensors associated with the interactive device;
determining an interaction intensity value associated with each of the users, wherein the interaction intensity value is indicative of the level of activity of the each of the users;
identifying at least one active user among the group of users based on an order of the interaction intensity values; and
tracking gestures of the at least one active user towards the gesture-based application for facilitating interactions with the gesture-based application.

10. The device of claim 9, wherein the sensors are selected from at least one of a camera, an infrared (IR) sensor, a Red-Green-Blue (RGB) sensor, a Sonar sensor, a laser sensor and a Radio Frequency (RF) sensor.

11. The device of claim 9, wherein the interactive device is associated with a display unit to display a notification for indicating the identified at least one active user, wherein the notification comprises at least one of a visual alert, an audio alert and an audio-visual alert.

12. The device of claim 9, wherein the memory stores one or more actions performed towards the gesture-based application by the at least one active user.

13. A non-transitory computer readable medium having stored thereon instructions for facilitating interactions with a gesture-based application comprising machine executable code which when executed by at least one processor, causes the processor to perform steps comprising:
identifying the group based on information received from sensors associated with an interactive device;
determining an interaction intensity value associated with each of the users, wherein the interaction intensity value is indicative of the level of activity of the each of the users;
identifying at least one active user among the group of users based on an order of the interaction intensity values; and
tracking gestures of the at least one active user towards the gesture-based application for facilitating interactions with the gesture-based application.

14. The medium of claim 13, wherein the instructions further cause the processor to perform operations comprising:
assigning a unique identifier to the at least one active user; and
creating a unique session for the at least one active user for facilitating interactions with the gesture-based application.

15. The medium of claim 13, wherein the instructions further cause the processor to perform operations comprising generating a notification for indicating the identified at least one active user, wherein the notification comprises at least one of a visual alert, an audio alert and an audio-visual alert.

16. The medium of claim 13, wherein the instructions further cause the processor to perform operations comprising the identifying of the at least one active user among the group of users is based on descending order of the interaction intensity values.

17. The medium of claim 13, wherein the instructions further cause the processor to perform operations comprising storing one or more actions performed towards the gesture-based application by the at least one active user in a memory of the computing unit

18. The medium of claim 13, wherein the instructions further cause the processor to perform operations comprising identifying a change in the group of users by identifying at least one of addition and deletion of at least one user in the group.

19. The medium of claim 13, wherein the instructions further cause the processor to perform operations comprising identifying a change of the at least one active user in the group based on a change in the interaction intensity values.
